(19) United States
(12) Patent Application Publication
(10) Pub. No.: US 2014/0366054 A1
(43) Pub. Date: Dec. 11, 2014

(54) ELECTRONIC APPARATUS AND CONTROL METHOD THEREOF

(71) Applicants: KABUSHIKI KAISHA TOSHIBA, Tokyo (JP); Toshiba Lifestyle Products & Services Corporation, Tokyo (JP)

(72) Inventor: Yusuke Fukai, Tokyo (JP)

(21) Appl. No.: 14/468,220

(22) Filed: Aug. 25, 2014

Related U.S. Application Data
(63) Continuation of application No. PCT/JP2013/065278, filed on May 31, 2013.

(51) Int. Cl. H04N 21/418; H04N 21/431; H04N 21/435; H04N 21/8543; H04N 21/438; H04N 21/443; H04N 21/472; H04N 21/81; H04N 21/426; H04N 21/437

(52) U.S. Cl. CPC H04N 21/4183; H04N 21/4181; H04N 21/42607; H04N 21/4316; H04N 21/435; H04N 21/437; H04N 21/438; H04N 21/4431; H04N 21/472; H04N 21/8173; H04N 21/8186; H04N 21/8543
USPC 725/25

(57) ABSTRACT

According to one embodiment, an electronic device including, a card processor, a first application processor, a second application processor, a display processor, an image output controller and a controller. The card processor to transfer data to a card device includes a signal processor. The first application processor to execute a first application for launching and finishing an operation of the signal processor of the card device authenticated by the card processor, or for selecting the card device from card devices. The second application processor to execute a second application for providing as a user interface for operating the signal processor of the card device authenticated by the card processor.

### CROSS-REFERENCE TO RELATED APPLICATIONS

This application is a Continuation Application of PCT Application No. PCT/JP2013/065278, filed May 31, 2013, the entire contents of which are incorporated herein by reference.

### FIELD

Embodiments described herein relate generally to an electronic apparatus and a control method thereof.

### BACKGROUND

In an electronic apparatus comprising a monitor device of a television broadcast receiver, etc., the monitor device is getting larger recently, while a signal processor which receives broadcasts is getting smaller. Further, for example, the television broadcast receiver is requested not only to receive broadcasts but to support signal processing of a streaming image from a network, and an image transfer technique which uses a network function such as the Digital Living Network Alliance (DLNA) standard or the Wireless Display-Distribution System (WiDi) standard.

Thus, it is desired to support standards of television broadcasts in various countries or to propose a method of realizing a hardware or software structure which facilitates function enhancement by separating a monitor device (monitor unit) and a card device which is the signal processor which performs the signal processing, and by making the card device detachable.

Further, more recently, means of realizing a graphical user interface (GUI) of an image display system using HTML/JavaScript (registered trademark) on a Web browser in consideration of facility of the function enhancement, versatility covering a subsequent model, a number of models, etc., is being considered and realized.

Although an image display system in which function enhancement can be performed using a detachable card is already present, communication between a monitor unit and a card device using HDMI, USB, PCIexpress, etc., as a signal transmission standard are limited to the signal transmission standard.

Thus, a distinct system has to be constructed if a function is extended and used.

Further, if HTML/JavaScript technology is used in the distinct system as described above, a complex system structure is added to both the monitor unit and the card device.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of an electronic apparatus which applies an embodiment;

FIG. 2 shows an example of a flowchart illustrating an example of an operation according to the embodiment;

FIG. 3 shows an example of a sequential chart illustrating an example of the operation according to the embodiment;

FIG. 4 shows an example of a sequential chart illustrating an example of the operation according to the embodiment; and

FIG. 5 shows an example of a display example of a display screen according to the embodiment.

### DETAILED DESCRIPTION

Various embodiments will be described hereinafter with reference to the accompanying drawings.

In general, according to one embodiment, an electronic device comprising, a card processor, a first application processor, a second application processor, a display processor, an image output controller and a controller. The card processor to transfer data to a card device comprising a signal processor. The first application processor to execute a first application for launching and finishing an operation of the signal processor of the card device authenticated by the card processor, or for selecting the card device from card devices. The second application processor to execute a second application for providing as a user interface for operating the signal processor of the card device authenticated by the card processor. The display processor to display an image in accordance with operations of the first and second application processors. The image output controller to output an output signal corresponding to the image in accordance with operations of the first and second application processors displayed by a display. The controller to control operations of the first and second application processors and the image output controller.

Hereinafter, one embodiment of the present invention will be described with reference to the accompanying drawings.

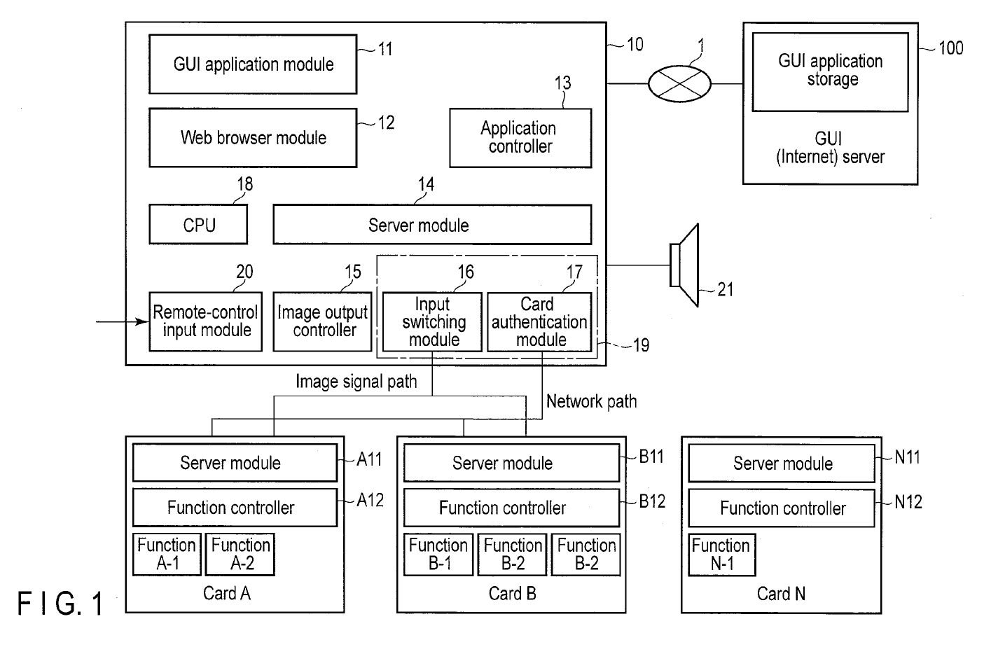

FIG. 1 shows an example of an electronic apparatus, such as an image display system comprising a monitor unit (image display unit) and a signal processor. It should be noted that elements and structures which will be described below may be those which can be realized by software using a microcomputer (processor or central processing unit [CPU]), or those which can be realized by hardware. Further, the way for acquiring content displayed by the monitor unit is arbitrary, such as utilizing a space wave (radio wave), utilizing a network which uses a cable (including optical fiber), an Internet Protocol (IP) communication network, etc., and utilizing an image transfer technique which uses signal processing of a streaming image from the network or a network function. It should be noted that the content may be referred to as a stream, a program, or information, and includes an image and speech or music, etc. Further, the image includes a moving image, a still image or a text (information represented by a character, a symbol, etc., indicated by a coded code string), and an arbitrary combination thereof.

The electronic apparatus shown in FIG. 1 comprises a monitor unit 10, a GUI application module 11, a Web browser (file browsing processing) module 12, an application controller 13, a server module 14, an image output controller 15, an input switching module 16, a card authentication module 17, a controller (central processing unit [CPU]) 18, a card installation portion 19, a remote-control input module 20, etc.

The monitor unit 10 displays an image (content) output by the image output controller 15 in accordance with a function provided by a card installed on the card installation portion 19. It should be noted that a plurality of cards can be installed on the card installation portion 19.

The graphical user interface (GUI) application module 11 holds a GUI application written in, for example, Hypertext Markup Language (HTML)/JavaScript (registered trademark).

The Web browser module 12 executes, under the control of the CPU 18, a browser function based on an arbitrary GUI application stored in the GUI application module 11.

The application controller 13 controls launching and finishing of an application, or an application (focus) which is operating (activated) among a plurality of applications under the control of the CPU 18.

The application controller 13 includes, for example, a Web server or a WebSocket server, and, under the control of the CPU 18, performs authentication by the card authentication module 17, network path setting for a card which could be authenticated by the input switching module 16, setting of an image signal path by the image output controller 15, etc.

It should be noted that if a card is not installed, the server module 14 controls GUI display corresponding to a control GUI application of the monitor unit 10 prepared in advance in the monitor unit 10 (GUI application module 11), and display of the monitor unit 10 which follows control input corresponding to the GUI display.

Card devices, for example, card A which can realize a first function, card B which can realize a second function and card N (where N is a positive integer), include server portions A10, B10 and N10, and function controllers A11, B11 and N10, respectively. It should be noted that card A can execute function A-1 and function A-2. Further, card B can execute function B-1 to function B-3. Furthermore, card N can execute function N-1.

In each of the cards (card devices), server portions A10, B10 and N10 include, for example, an HTTP server or a WebSocket server in HTML5, and can perform two-way communication which uses the Internet server technology. It should be noted that as the image output (transmission) standard, each of the cards (card devices) conforms to the transmission standard such as the High-definition Digital Media Interface (HDMI) standard or the Universal Serial Bus (USB) standard, and also comprises a communication interface conforming to Ethernet (registered trademark).

That is, the monitor unit 10 communicates with a card which has been authenticated by the card authentication module 17 with GUI application 11 which runs on the Web browser 12 included in the monitor unit 10, and by which input switching has been completed by the input switching module 16, and can realize the operations of the card devices, that is, card A/card B/card N, and the functions provided in each of the cards.

It should be noted that the CPU 18 may be integral with, for example, the server module 14 or the application controller 13, or alternatively, the server module 14 or the application controller 13 may be provided as firmware of the CPU 18.

Also, a speaker (audio reproducer) 21, which reproduces speech (audio) output by a speech output controller, is connectable to the monitor unit 10, although this is not described in detail.

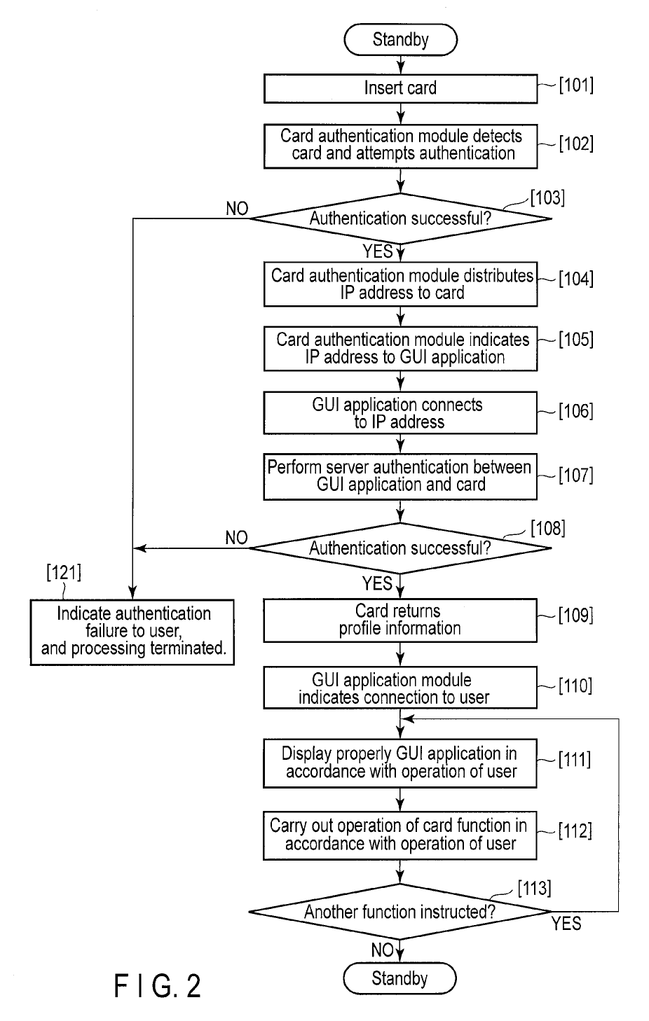

FIG. 2 describes an example of an operation of the embodiment (hardware configuration) shown in FIG. 1 in the form of a flowchart.

When an arbitrary card is inserted into the card installation portion 19 of the monitor unit 10 [101], the card authentication module 17 detects the insertion of the card and attempts authentication [102]. It should be noted that an authentication method is arbitrary, and various methods (schemes) put to practical use can be utilized.

If the authentication is successful [103-YES], the card authentication module 17 distributes an Internet Protocol (IP) address to the inserted card [104]. The card uses the distributed IP address, and launches the server portion of its own.

If the authentication cannot be performed (authentication failure) [103-NO], the authentication failure is indicated to a user (by displaying a message, etc., in a predetermined region of the monitor unit 10), and the processing is terminated (returns to a standby state).

Also, the card authentication module 17 indicates the IP address distributed to the card to the GUI application module 11 [105]. It should be noted that connection of the GUI application module 11 is established to the server module 14 of the monitor unit 10, for example, at the time of launching a system. Further, the card authentication module 17 holds a list of authenticated cards and IP addresses thereof, and indicates an IP address to the GUI application module 11 if a newly-authenticated card is added.

Next, the GUI application module 11 connects to the IP address of the indicated card [106].

Subsequently, client authentication is performed between the GUI application module 11 and a server module of a card [107]. This allows connection from an unauthorized client to be refused, for example, if a GUI application is downloaded from a GUI (Internet) server 100, as will be described later.

If the authentication cannot be performed between the GUI application module 11 and the server module (authentication failure) [108-NO], the authentication failure is indicated to a user (by displaying a message, etc., in a predetermined region of the monitor unit 10), and the processing is terminated (returns to a standby state).

If the authentication between the GUI application module 11 and the server module of the card is successful [108-YES], the card returns profile information to the GUI application module 11 [109]. It should be noted that the profile information includes, for example, information concerning, for example, the name of the card or a list of functions of the card. Further, the profile information may include a URL (address in the GUI [Internet server] 100) in which a GUI application to be downloaded is located, etc.

Here, if the card is, for example, a tuner card for digital television broadcasting, the functions of the card include:

a channel setting function such as channel scanning;

an information acquisition function of a set channel;

a channel tuning function;

an information acquisition function of service information (SI) of a channel being viewed; and

a stream switching function of a channel being viewed.

On the other hand, if the card is, for example, a tuner card for pay digital television broadcasting, they include:

a channel setting function such as channel scanning;

an information acquisition function of a contracted channel;

an information acquisition function of service information (SI) of a contracted channel;

a channel tuning function; and

a password management function for a channel with a viewing age limit.

It should be noted that when this image display system is established, an all functions list as a superset is predefined, and the above-described functions are realized by indicating which function in the list is supported.

The GUI application module 11 which received return of the profile information (card information) from the card indicates to a user that an arbitrary card is connected. That is, after the name, etc., of the card and the insertion of the card are indicated from the GUI application module 11 to the application module 13 and the server module 14, a GUI (image) urging selection of a card is displayed in a predetermined region of the monitor unit 10 as image output from the image output controller 15 to urge selection of a user [110]. That is, the user can determine whether to launch a GUI application corresponding to the inserted card (whether to execute the functions of the card), and the card goes into a standby state where instruction input from a user is awaited.

A suitable GUI application (to be selected depending on a card) will be displayed in accordance with an operation of a user (selection instruction input by a user) [111]. That is, when the GUI application is launched in the selected card, download of the GUI application is attempted from the GUI (Internet) server 100 in accordance with a URL included in the profile information of the card.

It should be noted that if the download of the GUI application is unsuccessful due to, for example, an unconnected network, the monitor unit 10 or a GUI application pre-embedded in the card is launched. In this case, degenerate functions are sometimes provided, that is, part of the functions of the GUI application to be downloaded from the GUI (Internet) server 100 is sometimes limited; however, basic functions are available.

On the other hand, if the GUI application can be downloaded from the GUI (Internet) server 100, the Web browser module 12 is requested to newly generate a Web page in addition to the GUI application which communicates with the application controller 13 which realizes a function unique to the monitor unit 10, and is load the generated Web page. This allows a function of executing a plurality of applications simultaneously in a display screen of the monitor unit 10 to be realized. It should be noted that since the new-downloaded GUI application does not connect to a server module of a card, the connection to the server module of the card starts (connection is established) in accordance with [109] and [110] described above.

After the connection to the server module of the card is established, the functions of the card device can be properly used in accordance with an operation of a user. It should be noted that the application controller 13 manages a currently-focused GUI application (in which a button display is specified in a display screen, and, for example, a display color is inverted), and properly distributes a control command corresponding to operation input of a remote-control key which is input from the remote-control input module 20. That is, it carries out an operation of a card function selected in accordance with a remote-control operation of a user [112].

At this moment, depending on the state of the monitor unit 10, a display screen belonging to a specific GUI application may be exclusively displayed in accordance with unloading processing of a Web page operated by a GUI application, for example, an instruction of a user (remote-control operation).

It should be noted that if implementation of another function unique to the card is selected [113-YES], a GUI application corresponding to an operation of a user (input of a control command by an operation of a remote-control key) can be downloaded and displayed, and a card function corresponding to the displayed GUI application can be operated (repetition of [111] and [112]).

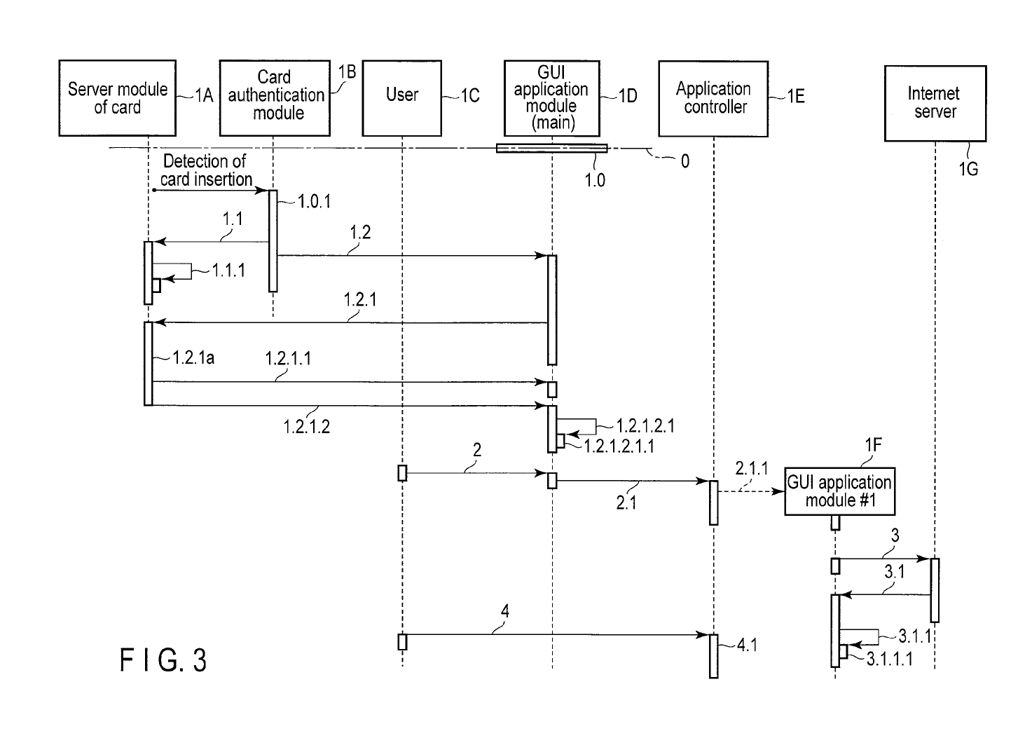

FIG. 3 illustrates an example of an operation of the embodiment (hardware structure) shown in FIG. 1 in a sequential chart form, taking a case where a card (signal processor) is present as an example.

It should be noted that in FIG. 3, a card-side server module 1A (corresponding to [A11] in FIG. 1), a card authentication module 1B (corresponding to [17] on the side of the monitor unit 10), a user 10, a GUI application module 1D (main [corresponding to [11] on the side of the monitor unit 10]), an application controller 1E (corresponding to [13] on the side of the monitor unit 10), a GUI application module #1 1F (an arbitrary GUI application stored in a GUI application storage of the GUI [Internet] server 100) and a GUI (Internet) server 1G (corresponding to [100] in FIG. 1) are defined.

In a (standby) state <0.1> where only a control application of the monitor unit 10 in a state where a card is not yet inserted <0> operates, when insertion <1> of a card is detected in the card authentication module 1B, card authentication processing is performed <1.0.1>. It should be noted that an authentication method is arbitrary, and various methods (schemes) put to practical use can be utilized.

When the authentication of the card is successful in the card authentication processing <1.0.1>, an IP address is distributed from the card authentication module 1B to the card-side server module 1A <1.1>. Further, the IP address distributed to the card-side server module 1A is indicated from the card authentication module 1B to the GUI application module 1D <1.2>.

A server operation starts in the card-side server module 1A to which the IP address is distributed <1.1.1>.

Further, authentication processing of a client which performs a connection request, that is, a connection request from the GUI application module 1D to the card-side server module 1A is performed <1.2.1>. It should be noted that an authentication method is arbitrary, and various methods (schemes) put to practical use can be utilized.

In the case of authentication success, that is, if connection responding to a connection request is successful in the card-side server module 1A <1.2.1a>, the connection success is indicated from the card-side server module 1A to the GUI application module 1D <1.2.1.1>. Further, profile information is indicated from the card-side server module 1A to the GUI application module 1D <1.2.1.2>.

The GUI application module 1D which received the profile information displays card information <1.2.1.2.1>. It should be noted that the card information is continuously displayed until application activation selection <2> from the user 1C is input, or for a predetermined time (period) <1.2.1.2.1.1>.

When the application activation selection <2.> from the user 10 is input, the GUI application module 1D transmits (issues) a new application activation request <2.1> to the application controller 1E.

The application controller 1E which received the new application activation request transmits (issues) a generation (creation) command to the GUI application module (#1) 1F <2.1.1>.

The GUI application module (#1) 1F which received the generation (creation) command transmits (issues) a download request <3> to the GUI (Internet) server 1G.

The GUI (Internet) server 1G which received the download request transmits a response <3.1> to the GUI application module (#1) 1F.

The GUI application module (#1) 10 which received the response <3.1> continuously displays application screen display until remote-control key input <4> from the user 1C is input, or for a predetermined time (period) <3.1.1>.

When the remote-control key input <4> from the user 1C is present, the application controller 1E transfers a certain type of remote-control key to the GUI application module 1D (main) and transfers a certain type of remote-control key to the GUI application module (#1) 1F in accordance with types of remote-control keys.

The application controller 13 manages a currently-focused GUI application (in which a button display is specified in a display screen, and, for example, a display color is inverted), and properly distributes a control command corresponding to operation input of a remote-control key which is input from the remote-control input module 20. That is, it carries out an operation of a card function selected in accordance with a remote-control operation of a user.

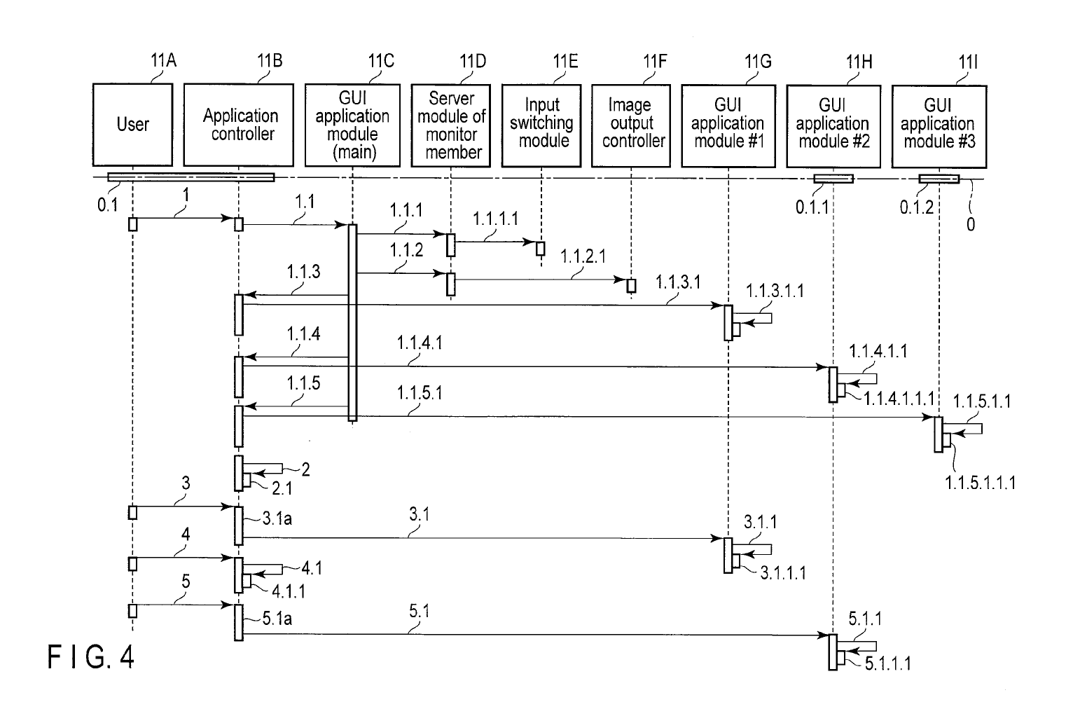

FIG. 4 illustrates an example of an operation of the embodiment (hardware structure) shown in FIG. 1 in a sequential chart form, taking a case where three cards (signal processors) are present as an example.

It should be noted that in FIG. 4, a user 11A, an application controller 11B (corresponding to [13] on the side of the monitor unit 10), a GUI application module 11C (main [corresponding to [11] on the side of the monitor unit 10]), a monitor-side server module 11D (corresponding to [14] on the side of the monitor unit 10), an input switching module 11E (corresponding to [16] on the side of the monitor unit 10), an image output controller 11F (corresponding to [15] on the side of the monitor unit 10), a GUI application module #1 11G (arbitrary GUI application #1 stored in a GUI application storage of the GUI [Internet] server 100), a GUI application module #2 11H (arbitrary GUI application #2 stored in the GUI application storage) and GUI application module #3 11I (arbitrary GUI application #3 stored in the GUI application storage) are defined.

It should be noted that in the following description, a case where the user 11A instructs and inputs a request to execute a plurality of applications <1> from a remote-control key in a state where card A and card B are already inserted and authenticated <0>, in a state where image (video) display and a GUI application display image of card A are being displayed full-screen in the monitor unit 10 <0.1>, and in a state where a GUI application display screen conforming to the GUI application module (#2) 11H and the GUI application module (#3) 11I is in non-display states <0.1.1> and <0.1.2> will be supposed.

When the user 11A instructs and inputs the request to execute the plurality of applications <1> from the remote-control key, instruction input (command) by the remote-control key is transferred from the application controller 11B to the GUI application module 11C (main) <1.1>.

The GUI application module 11C (main) which accepted the instruction input (command) by the remote-control key transmits (issues) an input acceptance request to the monitor-side server module 11D <1.1.1>.

The monitor-side server module 11D transmits (issues) card B input acceptance (request) for accepting input of card B to the input switching module 11E <1.1.1.1>.

The GUI application module 11C (main) which accepted the instruction input (command) by the remote-control key also transmits (issues) an image (video) display position change request to the monitor-side server module 11D <1.1.2>.

The monitor-side server module 11D which accepted the image (video) display position change request indicates the image (video) display position change requests of cards A and B to the input switching module 11E <1.1.2.1>.

The GUI application module 11C (main) also transmits (issues) an application #1 display position change request for requesting the application controller 11B to change the display position of application #1 <1.1.2>.

The application controller 11B corresponds to the application #1 display position change request, and transmits (issues) Web page display position/size change (request) to the GUI application module (#1) 11G <1.1.2.1>.

The GUI application module (#1) 11G which accepted the Web page display position/size change (request) updates a GUI screen <1.1.3.1.1>.

The GUI application module 11C (main) also transmits (issues) an application #2 display position change request for requesting the application controller 11B to change the display position of application #2 <1.1.2>.

The application controller 11B corresponds to the application #2 display position change request, and transmits (issues) Web page display position/size change (request) to the GUI application module (#2) 11H <1.1.3.1>.

The GUI application module (#2) 11H which accepted the Web page display position/size change (request) updates a GUI screen. It should be noted that the display of the updated GUI screen is maintained <1.1.4.1.1>.

The GUI application module 11C (main) further transmits (issues) an application #3 display position change request for requesting the application controller 11B to change the display position of application #3 <1.1.4>.

The application controller 11B corresponds to the application #3 display position change request, and transmits (issues) Web page display position/size change (request) to the GUI application module (#3) 11I <1.1.4.1.>.

The GUI application module (#3) 11I which accepted the Web page display position/size change (request) updates a GUI screen. It should be noted that the display of the updated GUI screen is maintained <1.1.5.1.1>.

As shown above, in a state where three GUI screen displays are displayed, the application controller 11B sets, the GUI application (#1) 11F to a focus state as an initial state <2.1> in application focus management <2>.

In this state, if a remote-control key operation (control input) <3> by the user 11A is present, a certain type of remote-control key is transferred to the GUI application module 11C (main) and a certain type of remote-control key is transferred to the GUI application (#1) 11F, that is, an application being focused in accordance with types of remote-control keys <3.1a>.

Next, the application controller 11B transfers a remote-control key (control input) to the GUI application (#1) 11F <3.1>.

The GUI application (#1) 11F which accepted the remote-control key (control input) updates GUI screen display. At this moment, the GUI application (#1) 11F requests a server of corresponding card A to acquire information and perform processing as necessary <3.1.1.1>.

It should be noted that if there is a case where a change of an application to be focused is instructed by a remote-control key operation (control input) by the user 11A <4>, the application controller 11B changes the application to be focused based on a remote-control key (control input) <4.1>. If the remote-control key (control input) is control input for setting, for example, application #2 to a focus state, the application controller 11B sets the GUI application (#2) 11G to a focus state <4.1.1>.

In this state, if a remote-control key operation (control input) <5> by the user 11A is present, a certain type of remote-control key is transferred to the GUI application module 11C (main) and a certain type of remote-control key is transferred to the GUI application (#2), that is, an application being focused in accordance with types of remote-control keys <5.1a>.

The GUI application (#2) 11G which accepted the remote-control key (control input) updates GUI screen display. At this moment, the GUI application (#2) 11G requests a server of corresponding card B to acquire information and perform processing as necessary <5.1.1.1>.

It should be noted that although a GUI application is executed in the Web browser module 13 of the monitor unit 10 in the embodiment shown by FIGS. 2 to 4, the browser may be an external Web browser different from the monitor unit 10. For example, a Web browser can be installed on any of card A, card B, . . . , card N, or each of them. Alternatively, it can be executed in a Web browser of a tablet device in which a type of operating system (OS) such as Android (registered trademark) is installed, and that of a mobile device represented by a smartphone in which, for example, iOS (registered trademark) is installed, etc. In that case, the GUI application of the mobile device can connect to a server of a monitor unit (only to a server of a monitor unit), however, it cannot connect directly to a server of a card device. Thus, the monitor unit has to be equipped with a bridge function of Transmission Control Protocol (TCP)/Internet Protocol (IP).

Further, although execution of an HTML/JavaScript application on a Web browser is supposed, the Web browser is not necessarily used if the server module can execute a client function.

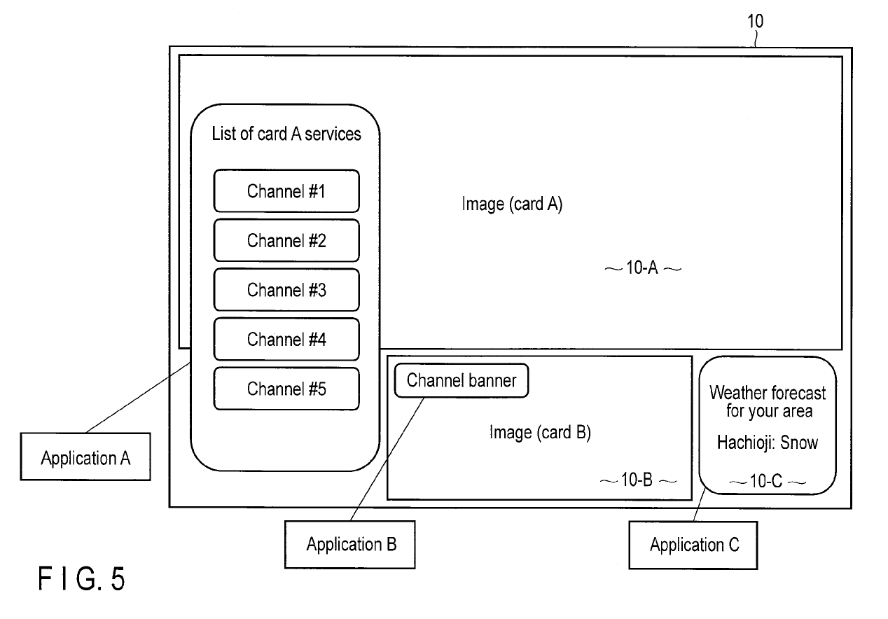

FIG. 5 shows an example of a display example of a display screen of a monitor unit into which two cards of a first card (card [signal processor] A) and a second card ([signal processor] card B) described based on FIGS. 1 to 4 are inserted.

The display example shown by FIG. 5 is an example in which an image (content) of a signal processed by card (signal processor) A and an image (content) of a signal processed by card (signal processor) B are displayed at the same time, and an example in which an image corresponding to application A in line with the function of card A is indicated in region 10-A and an image corresponding to application B in line with card B is indicated in region 10-B. It should be noted that as shown in FIG. 5, a function of displaying a signal which has been input to the monitor unit 10 complies not with a card but with setting by the input switching module 16 and the image output controller 15 of the monitor unit 10. That is, as described in FIG. 1, the GUI application module 11 can connect to the server module 14 of the monitor unit 10 and control the display of the monitor unit 10.

For example, application A indicates an example (list) of services which can be provided by card A (first card/signal processor), receives a program (content) of channel #1, channel #2, . . . , channel #5, and indicates that an image of each channel can be displayed.

Further, for example, application B indicates an example of services which can be provided by card B (second card/signal processor), and indicates an example of displaying content, a channel banner, etc., of an arbitrary website to be connected through, for example, the Internet server 100.

It should be noted that after region information used for channel scanning is acquired in, for example, card A, weather forecast information, etc., of the region (specified by the region information) is acquired from the Internet server 100, and application C can be executed in parallel with application A or B, or both of them. That is, application C indicates an example of executing an application on the Web browser 12 unique to the monitor unit 10, regardless of a function of an inserted card (signal processor) (independently of application A or B, or both of them).

It should be noted that a case where a signal processor is provided in a card is shown in the embodiment; however, a monitor unit can comprise antenna input and a signal processor. An advantage of this image display system is utilizing a function of a monitor unit and a card (device) as in a server set up on the Internet from the perspective of a GUI application, and hardware on which the function is realized in reality is not directly relevant.

Further, in the embodiment, since a function on the side of a card can be provided as in an Internet server, an interface between a card (device) and a main body (monitor unit) can be considerably simplified. Thus, the main body (monitor unit) can be disclosed extremely easily to a company in which manufacturing or designing is not performed (third vendor).

As described above, the embodiment allows function enhancement by a signal processor which is a card to be easily realized in an image display device (image display system) comprising a GUI application which uses HTML/JavaScript technology.

Further, by utilizing the embodiment, an image system for an arbitrary country can be easily provided by replacing a card (signal processor). That is, product cost can be reduced by providing a monitor unit with specifications common to the whole world.

Furthermore, information a portion below a function controller of a card (device) can be disclosed to a contract card vendor (signal processor production company), and the card (device) can be developed outside.

Moreover, the GUI application can be easily prepared by a card vendor. In particular, this is extremely effective in, for example, adapting a new content service provider (CSP) specific to on-demand distribution of contents.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, a function of performing two-way communication which uses the Internet server technology is installed on a card (signal processor), communication is performed from a Web browser prepared in a monitor unit, and an operation of a card device can be realized. In the server technology, a WebSocket, etc., in HTTP or HTML5 can be utilized, and the WebSocket should be preferably utilized to realize a two-way quick response.

Further, a card (signal processing) portion comprises a communication interface conforming to Ethenet, DLNA, WiDi, etc., as well as image output of HDMI, USB, etc., and the functions of the embodiment can be easily realized.

Further, after authenticating an installed card (signal processing), a monitor unit distributes an IP address to the card, and after indicating IP address information of the newly-installed card to a GUI application of the monitor unit, the monitor unit connects to the address. This allows connection from an unauthorized client to be refused.

Further, a GUI application which uses HTML/JavaScript constituted on a Web browser can be downloaded from the Internet. It should be noted that without connection to a network, a GUI application preinstalled in a monitor unit or a card device can be used.

Further, it suffices that the GUI application newly prepares a plurality of connections of a WebSocket, etc., even if a plurality of cards are installed. The GUI application can simultaneously use a plurality of cards and a function unique to a monitor unit, such as image output control.

What is claimed is:

1. An electronic device comprising:
a card processor to transfer data to a card device comprising a signal processor;
a first application processor to execute a first application for launching and finishing an operation of the signal processor of the card device authenticated by the card processor, or for selecting the card device from card devices;
a second application processor to execute a second application for providing as a user interface for operating the signal processor of the card device authenticated by the card processor;
a display processor to display an image in accordance with operations of the first and second application processors;
an image output controller to output an output signal corresponding to the image in accordance with operations of the first and second application processors displayed by a display; and
a controller to control operations of the first and second application processors and the image output controller.

2. The electronic device of claim 1, wherein the second application processor communicates with the card device, and operates the function of the signal processor of the card device.

3. The electronic device of claim 2, wherein the second application includes Hypertext Markup Language (HTML) and JavaScript.

4. The electronic device of claim 2, wherein the controller sets a communication path and an image signal path to a server module of the card device authenticated by the card processor.

5. The electronic device of claim 1, wherein the card device is usable in parallel.

6. The electronic device of claim 5, wherein the server module of the card device includes a WebSocket.

7. The electronic device of claim 1, further comprising:
a communication module to acquire the second application from outside.

8. The electronic device of claim 1, wherein the second application processor operates the first application using the function of the signal processor of the card device authenticated by the card processing module.

9. The electronic device of claim 8, wherein the card device authenticated by the card processor receives distribution of an address from the control module, and functions as a server which communicates with the second application processor.

10. A method for controlling an electronic device, the method comprising:
executing a first application for launching and finishing an operation of a signal processor of a card device, or for selecting the card device from card devices;
executing a second application for providing the signal processor of the card device specified by the first application; and
outputting an output signal corresponding to the image in accordance with operations of the first and second applications.

11. The method of claim 10, wherein the second application is acquirable through a network.

12. The method of claim 10, wherein the second application operates in accordance with Hypertext Markup Language (HTML) and JavaScript.

13. The method of claim 10, wherein the second application sets a communication path and an image signal path to a server module of an authenticated card device.

14. The method of claim 10, wherein the second application operates the first application using a signal processor of an authenticated card device.

15. The method of claim 10, wherein the second application executes a function of a signal processor of an authenticated card device.
